(19) United States
(12) Patent Application Publication
(10) Pub. No.: US 2011/0132709 A1
(43) Pub. Date: Jun. 9, 2011

(54) TORQUE CONVERTER

(75) Inventors: Takao Fukunaga, Kyoto (JP); Kazutoshi Nakayama, Osaka (JP)

(73) Assignee: EXEDY CORPORATION, Neyagawa-shi, Osaka (JP)

(21) Appl. No.: 13/056,879

(22) PCT Filed: Aug. 5, 2009
(86) PCT No.: PCT/JP2009/063871

§ 371 Date: Jan. 31, 2011

(30) Foreign Application Priority Data
Aug. 21, 2008 (JP) 2008-212311

(51) Int. Cl. F16H 45/02

(52) U.S. Cl. 192/3.23; 192/3.34; 192/3.29

(57) ABSTRACT

The present torque converter includes a front cover, an impeller, a turbine, a stator, a stator brake and thrust bearings. The stator brake brakes rotation of the stator and includes a brake case coupled to the stator, a brake fixation member coupled to a stationary shaft and a brake disc unit. One of the thrust bearings, disposed axially between the impeller and the brake case, supports the both members in a rotatable state. The other bearing supports the impeller and the brake fixation member in a rotatable state, while disposed between the members and axially closer to the engine than the thrust bearing is.

### TECHNICAL FIELD

The present invention relates to a torque converter, particularly to a torque converter including a stator brake disposed radial inward of a stator.

### BACKGROUND ART

The torque converters, including three types of bladed wheels (i.e., an impeller, a turbine and a stator), are devices configured to transmit torque via fluid within a torus formed by the bladed wheels. The impeller and a front cover form a fluid chamber that operating oil is filled in the inside thereof. The front cover receives torque inputted from an engine. Meanwhile, the turbine is axially opposed to the impeller while being disposed in the inside of the fluid chamber. A turbine hub, forming a part of the turbine, is coupled to an input shaft of a transmission. The stator is configured to regulate flow of the operating oil returning from the turbine to the impeller. The stator is disposed between the inner radial part of the impeller and the inner radial part of the turbine. Further, the stator is coupled to a stationary housing and the like through a one-way clutch.

A torque converter, including a brake for braking stator rotation instead of a well-known one-way clutch attached to a stator, has been produced (see patent literature 1). The torque convertor, described in patent literature 1, includes a stator brake and a lock-up clutch. The stator brake is disposed on the inner peripheral side of the stator whereas the lock-up clutch is disposed between the front cover and the turbine. The lock-up clutch is configured to change engaging force with the front cover and the impeller whereas the stator brake is configured to change engaging force with the stator, depending on difference between an operating oil pressure for turning on (i.e., locking) the lock-up clutch and an operating oil pressure for turning off (i.e., unlocking) the lock-up clutch.

### SUMMARY OF THE INVENTION

### Technical Problem

In the torque converter described in patent literature 1, the stator brake is disposed on the inner peripheral side of the stator. Therefore, a torus will be reduced within the torque converter when the brake disc has a large diameter for ensuring a large brake capacity. This negatively impacts on torque converter performance. In contrast, a space required for the stator brake will be reduced when the torus is increased for ensuring good torque converter performance. This prevents a sufficient brake capacity.

On the other hand, the stator brake will be axially elongated when the brake device includes a large number of disc plates for ensuring a sufficient brake capacity. This prevents reduction in axial size of the entire torque converter.

It is an object of the present invention to maintain torque converter performance and simultaneously form the stator brake in a compact size. Further, it is another object of the present invention to dispose the stator brake on the inner peripheral side of the stator without increasing the axial size of the torque converter.

### Solution to Problem

A torque converter according to a first aspect of the present invention is configured to transmit torque from an engine to an input shaft of a transmission via a fluid. The torque converter includes a front cover, an impeller, a turbine, a stator, a stator brake, a first slide member, and a second slide member. The front cover receives the torque from the engine. The impeller is connected to the front cover. The impeller forms a fluid chamber together with the front cover. The turbine is opposed to the impeller. The turbine is configured to output the torque to the transmission. The stator is disposed between an inner radial part of the impeller and an inner radial part of the turbine. The stator is configured to regulate a flow of the fluid flowing from the turbine to the impeller. The stator brake is configured to brake rotation of the stator. The stator brake includes a stator-side member, a fixation-side member and a brake disc unit. The stator-side member is coupled to the stator. The fixation-side member is disposed radial inward of the stator-side member. The fixation-side member is coupled to a non-rotatable member. The brake disc unit is disposed between the stator-side member and the fixation-side member. The first slide member is disposed axially between the impeller and the stator-side member. The first slide member supports the impeller and the stator-side member for allowing the impeller and the stator-side member to rotate. The second slide member is disposed axially between the impeller and the fixation-side member. The second slide member is disposed axially closer to the engine than the first slide member is. The second slide member supports the impeller and the fixation-side member for allowing the impeller and the fixation-side member to rotate.

According to the torque converter of the first aspect of the present invention, torque inputted to the front cover and the impeller is transmitted to the turbine via the fluid and further transmitted to the transmission. Further, the fluid flows from the impeller into the turbine and returns to the impeller through the stator. Yet further, stator rotation is braked by the stator brake. Torque converter capacity is thereby controlled.

The stator brake herein includes the stator-side member rotatable with the stator and the non-rotatable fixation-side member. These members are disposed closer to the impeller and configured not to rotate in synchronization with the impeller. However, the stator brake and the impeller are required to be close to each other for reducing the axial size of the torque converter.

In response, the first slide member is disposed between the impeller and the stator-side member forming a part of the stator brake, whereas the second slide member is disposed between the impeller and the fixation side member forming a part of the stator brake. The stator brake is supported by the first and second slide members for rotating relative to the impeller. Therefore, there is no useless space between the stator brake and the impeller. In other words, the torque converter can be compactly formed in the axial direction thereof. In addition, the second slide member, disposed on the further inner peripheral side, is axially disposed closer to the engine than the first slide member is. The structure helps further reduction in the axial size of the torque converter.

A torque converter according to a second aspect of the present invention relates to the torque converter according to the first aspect of the present invention. In the torque converter, the second slide member is disposed radial inward of the stator-side member for overlapping with the stator-side member along an axial direction thereof.

According to the torque converter of the second aspect of the present invention, the second slide member is overlapped with the stator-side member along the axial direction thereof. Therefore, the torque converter can be further compactly formed in the axial direction thereof.

A torque converter according to a third aspect of the present invention relates to the torque converter according to the first aspect of the present invention. The torque converter further includes a lock-up clutch configured to directly transmit the torque from the front cover to the turbine. The lock-up clutch includes a piston configured to be press-contacted to the front cover. Further, the turbine includes a turbine hub having a flanged portion and a tubular portion. The flanged portion has a disc shape. The tubular portion is axially extended and formed on an inner radial part of the flanged portion. The tubular portion is coupled to the input shaft of the transmission. The piston of the lock-up clutch is axially movably supported on the outer radial part of the flanged portion. The stator-side member includes a vertical wall portion, an outer tubular portion and an inner tubular portion. The vertical wall portion has a disc shape. The outer tubular portion is extended from an outer radial part of the vertical wall portion of the stator-side member towards the transmission. The inner tubular portion is extended from an inner radial part of the vertical wall portion of the stator-side member towards the transmission. The inner tubular portion of the stator-side member is rotatably supported by an outer peripheral surface of the tubular portion of the turbine hub.

According to the torque converter of the third aspect of the present invention, the inner tubular portion of the stator-side member is supported on the outer peripheral surface of the tubular portion of the turbine hub. Therefore, the torque converter can be further compactly formed in the axial direction thereof.

A torque converter according to a fourth aspect of the present invention relates to the torque converter according to the third aspect of the present invention. In the torque converter, the first slide member is disposed between an inner wall surface of the impeller and a transmission-side end surface of the outer tubular portion of the stator-side member.

A torque converter according to a fifth aspect of the present invention relates to the torque converter according to the fourth aspect of the present invention. The torque converter further includes a third slide member supporting the stator-side member for allowing the stator-side member to rotate. The third slide member is disposed between the turbine and an engine-side surface of the vertical wall portion of the stator-side member.

A torque converter according to a sixth aspect of the present invention relates to the torque converter according to the third aspect of the present invention. In the torque converter, the impeller includes a tubular portion in the inner radial part thereof. The tubular portion of the impeller is axially extended along the input shaft of the transmission. Further, the fixation-side member of the stator brake includes a vertical wall portion and an inner tubular portion. The vertical wall portion has a disc shape. The inner tubular portion is formed in an inner radial part of the vertical wall portion of the fixation-side member. The inner tubular portion is axially extended towards the transmission. The inner tubular portion of the fixation-side member is disposed on an inner peripheral side of the tubular portion of the impeller while being axially overlapped with the tubular portion of the impeller along an axial direction thereof.

According to the torque converter of the sixth aspect of the present invention, the inner tubular portion of the fixation-side member forming a part of the stator brake is overlapped with the tubular portion of the impeller along the axial direction thereof. Therefore, the torque converter can be further compactly formed in the axial direction thereof.

A torque converter according to a seventh aspect of the present invention relates to the torque converter according to the third aspect of the present invention. In the torque converter, the outer tubular portion of the stator-side member includes a plurality of teeth axially extended and circumferentially aligned on an outer periphery thereof. Further, the stator includes a plurality of teeth on an inner periphery thereof for meshing with the teeth formed on the outer tubular portion of the stator-side member.

According to the torque converter of the seventh aspect of the present invention, an area including the stator brake ensures a larger radial size. In other words, the discs forming the stator brake are allowed to have large diameters. Hence, a necessary brake capacity can be ensured with a small number of discs.

A torque converter according to an eighth aspect of the present invention relates to the torque converter according to the first aspect of the present invention. In the torque converter, a torus formed by the impeller, the turbine and the stator has an inner-outer diameter ratio of greater than or equal to 0.55. Further, the stator brake is disposed on an inner peripheral side of the torus.

According to the torque converter of the eighth aspect of the present invention, necessary torque converter performance can be maintained without increasing the number of discs of the stator brake.

### ADVANTAGEOUS EFFECTS OF INVENTION

According to the present invention, the stator brake can be compactly formed while maintaining torque converter performance. Further, the torque converter can be compactly formed in the axial direction thereof.

### BRIEF DESCRIPTION OF THE DRAWINGS

FIG. 1 is a schematic vertical cross-sectional view of a torque converter 1.

FIG. 2 is an enlarged fragmental view of FIG. 1

### DESCRIPTION OF EMBODIMENTS

### Entire Structure of Torque Converter

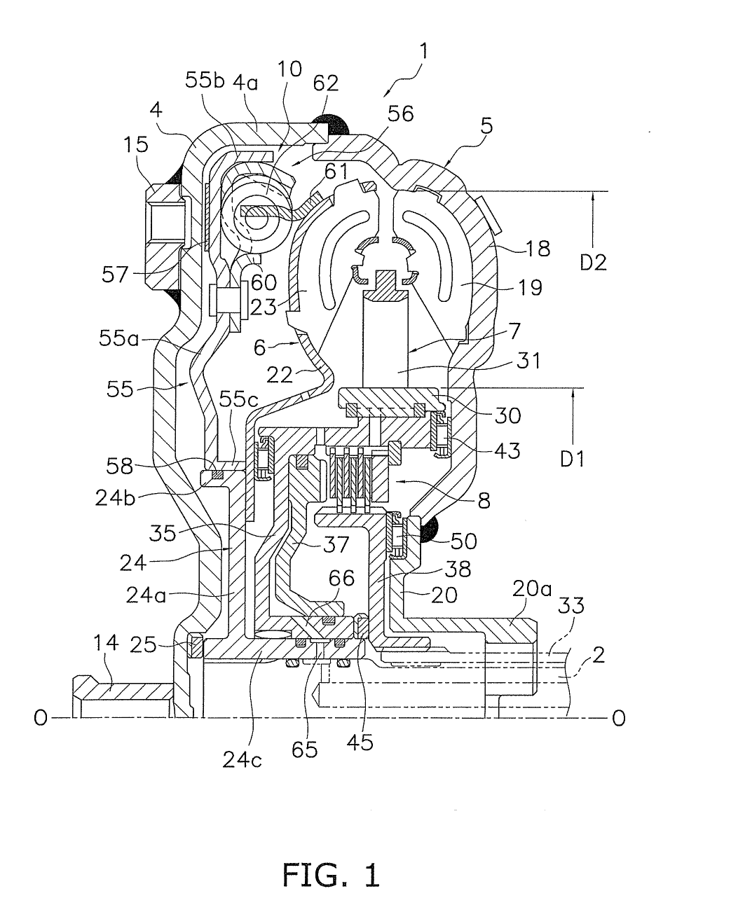

FIG. 1 is a vertical cross-sectional view of a torque converter 1 adopting an exemplary embodiment of the present invention. The torque converter 1 is a device configured to transmit torque from a crankshaft of an engine to an input shaft 2 of a transmission. The engine (not illustrated in the figures) is disposed on the left side in FIG. 1 whereas the transmission (not illustrated in the figures) is disposed on the right side in FIG. 1. A rotation axis of the torque converter 1 is depicted with a line O-O in FIG. 1.

The torque converter 1 mainly includes a front cover 4, three types of bladed wheels (i.e., an impeller 5, a turbine 6 and a stator 7), a stator brake 8 and a lock-up clutch 10.

[Front Cover]

The front cover 4 is a disc member that a center boss 14 is fixed to the inner radial part thereof by means of welding. The center boss 14 is an axially extended cylindrical member to be inserted into a center hole of the crankshaft (not illustrated in the figures).

The front cover 4 is coupled to the engine crankshaft through a flexible plate, although this is not illustrated in the figures. Specifically, a plurality of nuts 15 are fixed to the outer radial part of the engine-side surface of the front cover 4 while circumferentially aligned thereon at equal intervals. The outer radial part of the flexible plate is fixed to the front cover 4 by means of a plurality of bolts (not illustrated in the figures) respectively screwed into the nuts 15

The front cover 4 includes an outer radial tubular portion 4a on the outer radial part thereof. The outer radial tubular portion 4a is axially extended towards the transmission. The impeller 5 is fixed to the tip of the outer radial tubular portion 4a by means of welding. Consequently, the front cover 4 and the impeller 5 form a fluid chamber that operating oil is filled in the inside thereof.

[Impeller]

The impeller 5 mainly includes an impeller shell 18, a plurality of impeller blades 19 and an impeller hub 20. The impeller blades 19 are fixed to the inside of the impeller shell 18. The impeller hub 20 is fixed to the inner radial part the impeller shell 18. As described above, the tip of the outer radial part of the impeller shell 18 is welded to the front cover 4. Further, the impeller hub 20 includes a tubular portion 20a in the inner radial part thereof. The tubular portion 20a is extended towards the transmission.

[Turbine]

The turbine 6 is axially opposed to the impeller 5 while being disposed in the fluid chamber. The turbine 6 mainly includes a turbine shell 22, a plurality of turbine blades 23 and a turbine hub 24. The turbine blades 23 are fixed to the impeller-side surface of the turbine shell 22. The turbine hub 24 fixed to the inner radial edge of the turbine shell 22. The turbine shell 22 and the turbine hub 24 are fixed to each other by means of a plurality of rivets (not illustrated in the figures).

The turbine hub 24 includes a flanged portion 24a, an outer tubular portion 24b and an inner tubular portion 24c. The flanged portion 24a is a disc portion that the inner radial part of the turbine shell 22 is fixed. The outer tubular portion 24b is formed in the outer radial part of the flanged portion 24a while being axially extended towards the engine. The inner tubular portion 24c is formed in the inner radial part of the flanged portion 24a while being axially extended. Further, the inner tubular portion 24c includes a spline hole in the innerperiphery thereof. The spline hole is engaged with a spline shaft formed on the tip of the transmission input shaft 2. It should be noted that a thrust washer 25 is disposed between the front cover 4 and the tip of the inner tubular portion 24c of the turbine hub 24. The thrust washer 25 supports the front cover 4 and the turbine hub 24 while allowing them to rotate relative to each other.

[Stator]

The stator 7 is a mechanism disposed between the inner radial part of the impeller 5 and the inner radial part of the turbine 6 for regulating flow of the operating oil returning to the impeller 5 from the turbine 6. The stator 7 is integrally formed by means of casting of resin, aluminum alloy or the like. The stator 7 mainly includes an annular stator shell 30 and a plurality of stator blades 31 disposed on the outer peripheral surface of the stator shell 30. The stator shell 30 is supported by a tubular stationary (non-rotatable) shaft 33 through the stator brake 8. The stator shell 30 includes a plurality of teeth 30a axially extended and circumferentially aligned on the inner peripheral surface thereof. The stationary shaft 33 is disposed between the outer peripheral surface of the input shaft 2 and the inner peripheral surface of the tubular portion 20a of the impeller hub 20.

The aforementioned shells 18, 22 and 30 of the bladed wheels 5, 6 and 7 form a torus-shaped fluid operation chamber within the fluid chamber. In the present exemplary embodiment, the torus has an inner-outer diameter ratio (D1/D2) of 0.63. The torus preferably has an inner-outer diameter ratio of greater than or equal to 0.55 in consideration of torque converter performance, brake capacity of the stator brake to be described and the axial size of the stator brake. As illustrated in FIG. 1, the outer diameter D2 of the torus corresponds to the outer diameter of each impeller blade 19 while the inner diameter D1 of the torus corresponds to the outer diameter of the stator shell 30 (i.e., the inner diameter of each stator blade 31).

[Stator Brake]

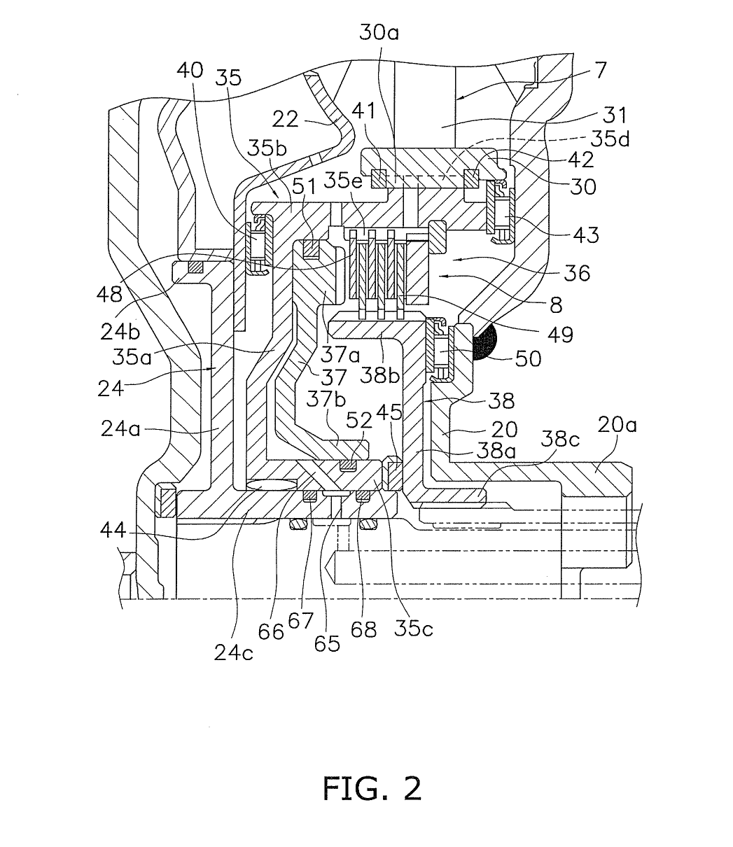

The stator brake 8 is disposed on the inner peripheral side of the stator 7 for braking rotation of the stator 7. The stator brake 8 is a hydraulic activation clutch brake. As illustrated in FIG. 2 in detail, the stator brake 8 includes a brake case 35 (i.e., a stator-side member), a brake disc unit 36, a piston 37, and a brake fixation member 38 (i.e., a fixation-side member). The brake disc unit 36 is of a plural disc type disposed in the inside of the brake case 35. The piston 37 is configured to press the disc brake unit 36. The brake fixation member 38 is coupled to the stationary shaft 33 while being disposed on the inner peripheral side of the brake disc unit 36.

<Brake Case>

As illustrated in FIG. 2, the brake case 35 includes a vertical wall portion 35a, an outer tubular portion 35b and an inner tubular portion 35c. The vertical wall portion 35a has a disc shape. The outer tubular portion 35b is extended from the outer radial part of the vertical wall portion 35a towards the transmission. The inner tubular portion 35c is extended from the inner radial part of the vertical wall portion 35a towards the transmission. The vertical wall portion 35a is disposed roughly in parallel to the flanged portion 24a of the turbine hub 24.

Further, a first thrust bearing 40 is disposed between the outer radial part of the vertical wall portion 35a and the inner radial part of the turbine shell 22. The first thrust bearing 40 is a bearing (i.e., a slide member) supporting the brake case 35 of the stator brake 8 for allowing the brake case 35 to rotate with respect to the turbine hub 24 (i.e., the turbine shell 22).

The outer tubular portion 35b includes a plurality of teeth 35d axially extended and circumferentially aligned on the outer peripheral surface thereof. Further, the outer tubular portion 35b includes a plurality of teeth 35e axially extended and circumferentially aligned on the inner peripheral surface thereof. The teeth 35d, circumferentially formed on the outer peripheral surface of the outer tubular portion 35b, mesh with a plurality of the teeth 30a formed on the inner peripheral surface of the stator shell 30. Further, a pair of snap rings 41, 42 is attached to the both axial ends of the teeth 30a on the inner peripheral surface of the stator shell 30. The aforementioned structure prevents relative rotation and relative axial movement of the brake case 35 and the stator shell 30.

Further, a second thrust bearing 42 is disposed between the impeller shell 18 and the axial tip surface of the outer tubular portion 35b. The second thrust bearing 43 is a bearing (i.e., a slide member) supporting the brake case 35 of the stator brake 8 for allowing the brake case 35 to rotate with respect to the impeller shell 18.

The inner tubular portion 35c is relative-rotatably supported by the outer peripheral portion of the inner tubular portion 24c of the turbine hub 24 through a roller bearing 44. In other words, the inner tubular portion 35c of the brake case 35 is overlapped with the inner tubular portion 24c of the turbine hub 24 along the axial direction thereof. It should be noted that a thrust washer 45 is disposed between the brake fixation member 38 and the axial tip of the inner tubular portion 35c.

<Brake Disc Unit>

The brake disc unit 36 includes a plurality of (four in the present example) driven plates 48 and a plurality of (three in the present example) discs 49. The driven plates 48 and the discs 49 are alternately disposed one besides the other along the axial direction thereof.

The driven plates 48 are ring-shaped members. Each driven plate 48 includes a plurality of teeth on the outer periphery thereof. The teeth of each driven plate 48 axial-movably mesh with the teeth 35e of the brake case 35. One of the four driven plates 48, disposed closest to the transmission, has a thickness greater than the thicknesses of the other three driven plates 48. The other three driven plates 48 are formed to have the same thickness.

Further, the discs 49 are ring-shaped members. Each disc 49 includes facings attached onto the both surfaces thereof as friction members. Each disc 49 includes a plurality of teeth on the inner periphery thereof.

<Piston>

The piston 37 includes a press portion 37a on the outer radial part thereof. The piston 37 is configured to press the brake disc unit 36 and thereby the driven plates 48 and the discs 49 are pressed to each other. The press portion 37a includes a plurality of grooves formed along radial directions thereof. Further, the piston 37 includes a tubular support portion 37b in the inner radial part thereof. The support portion 37b is axially extended towards the transmission. The support portion 37b is axial-movably supported on the outer peripheral surface of the inner tubular portion 35c of the brake case 35. It should be noted that a space between the piston 37 and the brake case 35 is sealed by two sealing members 51, 52. The sealing member 51 is disposed on the outer periphery of the piston 37, whereas the sealing member 52 is disposed the outer periphery of the inner tubular portion 35c of the brake case 35.

<Brake Fixation Member>

As illustrated in FIG. 2, the brake fixation member 38 includes a vertical wall portion 38a, an outer tubular portion 38b, and an inner tubular portion 38c. The vertical wall portion 38a has a disc shape. The outer tubular portion 38b is axially extended from the outer radial part of the vertical wall portion 38a towards the engine. The inner tubular portion 38c is axially extended from the inner radial part of the vertical wall portion 38a towards the transmission.

The outer tubular portion 38b includes a plurality of teeth axially extended and circumferentially aligned on the outer peripheral surface thereof. The teeth of the outer tubular portion 38b mesh with the teeth formed on the inner periphery of each disc 49. Further, the inner tubular portion 38c includes a spline hole in the inner peripheral surface thereof. The spline hole of the inner tubular portion 38c is engaged with a spline shaft formed on the outer peripheral surface of the stationary shaft 33. It should be noted that the inner tubular portion 38c is disposed on the inner peripheral side of the tubular portion 20a of the impeller hub 20. The inner tubular portion 38c and the tubular portion 20a are thus overlapped along the axial direction thereof.

Further, a third thrust bearing 50 is disposed between the impeller shell 18 and the outer radial part of the vertical wall portion 38a. The third thrust bearing 50 is a bearing (i.e., a slide member) supporting the non-rotatably fixed brake fixation member 38 for allowing it to rotate relative to the rotatable impeller hub 20.

The third thrust bearing 50 is herein disposed axially closer to the engine than the second thrust bearing 43 is. Further, the third thrust bearing 50 is disposed radial inward of the brake case 35 of the stator brake 8 while being overlapped with the outer tubular portion 35b of the brake case 35 along the axial direction thereof.

[Lock-up Clutch]

The lock-up clutch 10 is disposed between the front cover 4 and the turbine 6 for directly transmitting torque from the front cover 4 to the turbine 6. As illustrated in FIG. 1, the lock-up clutch 10 includes a piston 55 and a damper unit 56 disposed between the piston 55 and the turbine 6.

The piston 55 includes a piston body 55a, an outer tubular portion 55b, and an inner tubular portion 55c. The piston body 55a is provided with a friction member 57 fixed to the surface thereof opposed to the front cover 4. The outer tubular portion 55b is formed on the outer radial part of the piston 55. The inner tubular portion 55c is formed on the inner radial part of the piston 55. The inner tubular portion 55c is axial-movably supported by the outer tubular portion 24b of the turbine hub 24. It should be noted that the outer tubular portion 24b of the turbine hub 24 is provided with a sealing member 58 for sealing a space between the outer tubular portion 24b and the piston 55.

The damper unit 56 is disposed on the inner peripheral side of the outer tubular portion 55b of the piston 55. The damper unit 56 includes an input-side member 60, an output-side member 61, and a plurality of torsion springs 62. The input-side member 60 is fixed to the piston 55. The output-side member 61 is fixed to the turbine shell 22. The torsion springs 62 elastically couple the input-side member 60 and the output-side member 61.

[Stator Brake Activation Circuit]

As illustrated in FIG. 2, a circuit, configured to activate the stator brake 8, includes a through hole 65 and a through hole 66. The through hole 65 is formed in the inner tubular portion 24c of the turbine hub 24, whereas the through hole 66 is formed in the inner tubular portion 35c of the brake case 35. Specifically, the operating oil is supplied to the space between the brake case 35 and the piston 37 through the through holes 65, 66 for turning on the stator brake 8 (i.e., for pressing the discs). On the other hand, the operating oil is discharged through the aforementioned path (i.e., the through holes 65, 66) for turning off the stator brake 8 (i.e., for releasing pressure applied onto the discs). It should be noted that sealing members 67, 68 are disposed on the inner tubular portion 24c of the turbine hub 24 while axially interposing the through hole 65 therebetween.

[Actions of Torque Converter]

When the lock-up clutch 10 is turned off (i.e., released from a locked-up state), torque is transmitted between the front cover 4 and the turbine 6 by means of fluid transmission between the impeller 5 and the turbine 6. When the impeller 5 is rotated by the engine, the operating oil flows from the impeller 5 to the turbine 6 by the action of centrifugal force. When reaching the turbine 6 from the impeller 5, the operating oil rotates the turbine 6 and then passes through the stator 7. When passing through the stator 7, the operating oil strikes the stator blades 31, thereby changes the flow direction thereof, and returns to the impeller 5.

When the lock-up clutch 10 is turned on, on the other hand, the operating oil is discharged to the space between the piston 55 and the front cover 4. The piston 55 is thereby moved axially towards the front cover 4, and the friction member 57 fixed to the piston body 55a is pressed by the front cover 4.

Torque, transmitted from the engine to the front cover 4, is inputted into the damper unit 56 through the lock-up clutch 10 when the lock-up clutch 10 is turned on as described above. The torque is transmitted to the turbine 6 through the damper unit 56, and further transmitted to the input shaft 2 of the transmission through the turbine hub 24. The torque is thus directly transmitted towards the transmission.

The stator brake 8 is normally kept turned on during idling engine revolution (i.e., when the vehicle stops). In this case, the operating oil is supplied to the behind of the piston 37 (i.e., the space between the piston 37 and the brake case 35) via the through hole 65 of the turbine hub 24 and the through hole 66 of the brake case 35. The piston 37 is thereby axially moved towards the transmission. The driven plates 48 and the discs 49 are pressed to each other by the movement of the piston 37. The stator 7 is thereby braked and set to be in a non-rotatable state. While the stator 7 is braked, the torque converter has a relatively small capacity coefficient. In other words, the engine is less loaded. Hence, fuel consumption can be inhibited.

When the vehicle starts travelling, on the other hand, the stator brake 8 is shifted from a turned-on state (i.e., a braked state) to a turned-off state (i.e., an unbraked state). The capacity coefficient is thereby increased, and a sufficient torque converter capacity can be obtained for vehicle travelling. When the stator brake 8 is shifted from the turned-on state to the turned-off state, the operating oil, supplied to the behind of the piston 37, is discharged via the through holes 65, 66.

[Features of Present Exemplary Embodiment]

(a) The thrust bearing 43 is disposed between the brake case 35 of the stator brake 8 and the impeller 5, whereas the thrust bearing 50 is disposed between the brake fixation member 38 and the impeller 5. The stator brake 8 is thus supported by the thrust bearings 43, 55 for rotating relative to the impeller 5. Therefore, there is no useless space between the stator brake 8 and the impeller 5. Accordingly, the torque converter can be compactly formed in the axial direction thereof. Further, the third thrust bearing 50 is axially disposed closer to the engine than the second thrust bearing 43 is, while being contained in the inside of the brake case 35. The structure helps further reduction in the axial size of the torque converter.

(b) The inner tubular portion 35c of the brake case 35 is supported by the outer peripheral surface of the inner tubular portion 24c of the turbine hub 24. The structure helps further reduction in the axial size of the torque converter. Further, the inner tubular portion 38c of the brake fixation member 38 is overlapped with the tubular portion 20a of the impeller hub 20 along the axial direction thereof. The structure also helps further reduction in the axial size of the torque converter.

(c) The stator 7 and the stator brake 8 are coupled to each other with the plural teeth formed on the inner periphery of the stator 7 and the plural teeth formed on the outer periphery of the stator brake 8. An area including the stator brake ensures a larger radial size compared to the other coupling methods. The discs, forming the stator brake, are thereby allowed to have large diameters. Hence, a necessary brake capacity can be ensured with a small number of discs.

(d) The torus has an inner-outer diameter ratio (D1/D2) of greater than or equal to 0.55, and the stator brake 8 is disposed on the inner peripheral side of the torus. Similarly to the above, the area including the stator brake ensures a larger radial size. Hence, a necessary brake capacity can be ensured with a small number of discs. In other word, necessary torque converter performance can be maintained without increasing the number of discs of the stator brake.

### Other Exemplary Embodiments

The aforementioned exemplary embodiment exemplified a case that the stator brake is made up of a plurality of discs. However, the present invention can be similarly applied to the stator brakes of a single disc type.

Further, a specific structure of the lock-up clutch is not limited to that described in the aforementioned embodiment. Similarly, structures of the respective oil supply circuits are not limited to those described in the aforementioned exemplary embodiment.

### INDUSTRIAL APPLICABILITY

According to the torque converter of the present invention, the stator brake can be compactly formed while good torque converter performance is maintained. Further, the torque converter can be compactly formed in the axial direction thereof.

### REFERENCE SIGNS LIST

1 Torque converter
2 Input shaft of transmission
4 Front cover
5 Impeller
6 Turbine
7 Stator
8 Stator brake
20 Impeller hub
20a Tubular portion of impeller hub
24 Turbine hub
24a Flanged portion
24b Outer tubular portion
24c Inner tubular portion
35 Brake case
35a Vertical wall portion
35b Outer tubular portion
35c Inner tubular portion
36 Brake disc unit
37 Piston
38 Brake fixation member
38c Inner tubular portion
40, 43, 50 Thrust bearings
55 Lock-up clutch

### CITATION LIST

### Patent Literature

PTL 1: Japan Laid-open Patent Application Publication No. JP-A-2006-300099

1. A torque converter configured to transmit torque in an axial direction from an engine to an input shaft of a transmission via fluid, the torque converter comprising:
a front cover configured to receive the torque inputted from the engine;
an impeller being connected to the front cover, the impeller being configured to form a fluid chamber together with the front cover;
a turbine being configured to output the torque to the transmission;
a stator being configured to regulate flow of the fluid flowing from the turbine to the impeller, the stator being configured between inner radial part of the impeller and an inner radial part of the turbine;
a stator brake being configured to brake rotation of the stator, the stator brake including
a stator-side member being coupled to the stator, while being fixedly attached to the stator, the stator-side member being configured radially inward of the stator,
a fixation-side member being configured radially inward of the stator-side member, the fixation-side member being non-rotatable, and
a brake disc unit being configured between the stator-side member and the fixation-side member;
a first slide member being configured between the impeller and the stator-side member in the axial direction, the first slide member being configured to support rotatably the impeller and the stator-side member against each other; and
a second slide member being configured between the impeller and the fixation-side member in the axial direction, the second slide member being configured closer to the engine than to the first slide member, the second slide member being configured to support rotatably the impeller and the fixation-side member against each other.

2. The torque converter according to claim 1, wherein
the second slide member is configured radially inward of the stator-side member for overlapping with the stator-side member in the axial direction.

3. The torque converter according to claim 1, further comprising
a lock-up clutch being configured to transmit directly the torque from the front cover to the turbine, the lock-up clutch including a piston being configured to be pressed to and to be in contact the front cover, wherein
the turbine includes a turbine hub,
the turbine hub having
a flanged portion having a disc shape, and
a tubular portion being formed on an inner radial part of the flanged portion, the tubular portion extending in the axial direction and being coupled to the input shaft of the transmission,
the piston of the lock-up clutch is movably supported in the axial direction on an outer radial part of the flanged portion,
the stator-side member includes
a vertical wall portion having a disc shape,
an outer tubular portion extending from an outer radial part of the vertical wall portion of the stator-side member towards the transmission, and
an inner tubular portion extending from an inner radial part of the vertical wall portion of the stator-side member towards the transmission, and
the inner tubular portion of the stator-side member is rotatably supported by an outer peripheral surface of the tubular portion of the turbine hub.

4. The torque converter according to claim 3, wherein
the first slide member is configured between an inner wall surface of the impeller and a transmission-side end surface of the outer tubular portion of the stator-side member.

5. The torque converter according to claim 4, further comprising
a third slide member being configured to support rotatably the stator-side member, the third slide member being configured between the turbine and an engine-side surface of the vertical wall portion of the stator-side member.

6. The torque converter according to claim 3, wherein
the impeller includes a tubular portion in the inner radial part thereof, where the tubular portion extends along the input shaft of the transmission,
the fixation-side member of the stator brake includes
a vertical wall portion having a disc shape, and
an inner tubular portion being formed in an inner radial part of the vertical wall portion of the fixation-side member, the inner tubular portion axially extending towards the transmission, and
the inner tubular portion of the fixation-side member is configured on an inner peripheral side of the tubular portion of the impeller and is overlapped in the axial direction with the tubular portion of the impeller.

7. The torque converter according to claim 3, wherein
the outer tubular portion of the stator-side member includes a plurality of teeth formed in a plurality of circumferential rows aligned in the axial direction on an outer periphery thereof, and
the stator includes a plurality of teeth on an inner periphery thereof for meshing with the teeth formed on the outer tubular portion of the stator-side member.

8. The torque converter according to claim 1, wherein
a torus formed by the impeller, the stator, and the turbine,
the torus has an inner diameter and an outer diameter, where a ratio of the inner diameter to the outer diameter is greater than or equal to 0.55, and
the stator brake is configured on an inner peripheral side of the torus.
